(19) United States
(12) Patent Application Publication
(10) Pub. No.: US 2002/0150194 A1
(43) Pub. Date: Oct. 17, 2002

(54) Method and device for non-invasive soil carbon content and distribution measurements

(76) Inventors: Lucian Wielopolski, Ridge, NY (US); George Hendrey, Shoreham, NY (US)

Correspondence Address: Margaret C. Bogosian, Brookhaven National Laboratory, Bldg. 475D, P.O. Box 5000, Upton, NY, 11973-5000, US

(21) Appl. No.: 10/091,869

(22) Filed: Mar. 6, 2002

Related U.S. Application Data
(63) Continuation-in-part of application No. 09/626,763, filed on Jul. 27, 2000.

(51) Int. Cl. G21G 1/06

(52) U.S. Cl. 376/160

(57) ABSTRACT

A method and device for taking non-invasive on-site soil carbon content and distribution measurements at the surface of the soil utilizing a neutron generator positioned on the surface of the soil to generate neutrons that penetrate the soil. The neutrons cause inelastic neutron scattering (INS) from carbon and subsequent emission of gamma rays from the first carbon excited level. The gamma rays are measured by a number of suitable on-site gamma ray detectors situated near the neutron generator. A nuclear spectroscopy system is utilized to generate an energy spectrum of the detected emitted gamma rays and a net number of gamma rays is determined by subtracting a background count from a total count at a predetermined energy level. The net count is then compared to a predetermined calibration plot to determine the weight percentage of carbon within the measured soil.

### CROSS-REFERENCE TO RELATED APPLICATIONS

This application is a continuation-in-part of U.S. application Ser. No. 09/626,763, filed Jul. 27, 2000.

This invention was made with Government support under contract number DE-AC02-98CH10886, awarded by the U.S. Department of Energy. The Government has certain rights in the invention.

### BACKGROUND OF THE INVENTION

The present invention relates generally to a method and device for the non-invasive, in-situ measurement of carbon content and distribution in soil, and, more particularly, to a method and device for taking on-site, non-destructive soil measurements.

Predictions suggest that rising global atmospheric CO₂ has the potential to change global climates, which in the process could affect agriculture and threaten the stability of natural ecosystems. In order to mitigate global change, current increases in atmosphere CO₂ levels must be curtailed. The world's soils represent the largest terrestrial carbon sink and have great potential to sequester atmospheric carbon. In order to evaluate the capacity of soils to store carbon, new techniques allowing in situ, quantitative measures of soil carbon content must be developed. A rapid, noninvasive technique for quantifying soil carbon will not only enable plant and soil scientists to understand the capacity of different soils to store carbon, but will also provide useful information about the role of plants in this sequestration process. The development of fast, accurate methods for quantifying soil carbon will be invaluable for understanding the linkage of plant function to soil quality and their role in the global carbon cycle and the effects of till versus no-till agriculture. Such a technique would also be useful in standardizing carbon sequestration credits monitoring which is prevalent in many countries' environmental policies.

Various invasive and destructive techniques are generally known in the art to analyze carbon within soil for entirely different purposes, such as oil exploration. Some of these techniques utilize a neutron generator and one or more gamma ray and neutron detectors to measure the inelastic neutron scattering (INS) effects of carbon caused by the neutron generator.

For example, U.S. Pat. No. 5,374,823 to Odom discloses a well-logging tool for measuring the gamma radiation energy spectra for fast neutron inelastic collisions and thermal neutron capture events. The logging tool is in the form of an elongated probe for insertion into a well bored into a soil formation to a desired depth below the soil surface. The probe is intended to operate at depths of hundreds to thousands of feet below the surface. The tool includes a neutron source for generating neutron bursts and a gamma ray detector for measuring the resulting emitted gamma rays during a single logging pass over a well-depth interval. The tool is intended to locate hydrocarbon deposits well below the surface of the soil for oil exploration purposes.

U.S. Pat. No. 5,900,627 to Odom et al. discloses a similar well logging tool utilizing two gamma ray detectors within a housing of the probe located at different distances from the neutron source and spaced sufficiently from the source. Again, the tool is intended for invasive oil and gas well logging operations well below the surface of the soil.

U.S. Pat. No. 5,777,323 to Hemmingway also discloses a method and apparatus for determining a characteristic of an earth formation traversed by a borehole. A logging tool similar to those described above having a neutron source and at least one detector is lowered into the borehole to detect gamma rays resulting from the interaction of the neutrons with the atoms of the formation. A method is disclosed wherein two attributes of the formation are derived based on a linear correlation value determined by the detected gamma rays.

U.S. Pat. No. 5,808,298 to Mickael discloses a method for determining oil saturation in an earth formation penetrated by a wellbore. The method involves measuring relative amounts of carbon and oxygen by spectral analysis of neutron-induced gamma rays. The relative amounts of carbon and oxygen are used to calculate an apparent oil holdup in the wellbore at each one of several spaced apart locations. The patent also discloses a carbon-oxygen well logging instrument for making the measurements comprising an elongate housing containing a neutron source and a near and far detector.

Alternative techniques for measuring soil carbon content involve taking core soil samples to a suitable laboratory for destructive testing off-site. Such testing techniques include combustion testing and/or chemical analysis. Accordingly, these techniques are very labor intensive, destructive and time consuming.

Each of the above four patents discloses a method and/or device for invasively measuring soil characteristics using a well logging tool. It would be desirable to provide a method and device for determining the soil carbon content by non-invasively measuring the soil on-site at the soil surface.

### SUMMARY OF THE INVENTION

The present invention is a method and device for making non-invasive soil carbon content and distribution measurements at the surface of the soil. The device is a field deployable unit using a neutron generator positioned on the surface of the soil to generate fast neutrons that penetrate the soil. The neutrons cause inelastic neutron scattering (INS) from carbon and subsequent emission of gamma rays from the first carbon excited level. The gamma rays are measured by a number of suitable on-site gamma ray detectors situated near the neutron generator. A nuclear spectroscopy system is utilized to generate an energy spectrum of the detected emitted gamma rays and a net number of gamma rays is determined by subtracting a background count from a total count at a predetermined energy level. The background count is calculated using experimental data or through known graphical interpolation or modeling techniques. The net count is then compared to a predetermined calibration plot to determine the weight percentage of carbon within the measured soil. Thus, repeated measurements at the same soil surface site can be made in the field.

Other elements such as silicon, oxygen, calcium and nitrogen can also be measured using this system and methodology. To determine the weight percentage of other elements in the soil, net gamma ray counts are calculated as described above at other known energy levels corresponding to the other elements. As a result, an element by element analysis of the measured soil can be determined. Additionally, a compartmental analysis can be performed to identify the organic and inorganic carbon components in the soil.

In the preferred embodiment, time information is considered during the gamma ray detection process to improve sensitivity and reduce background noise. Thus, it is preferred that the gamma ray energy spectrum be generated for gamma ray emission occurring only during a predetermined time period. Accordingly, the method may include the step of detecting an associated alpha particle emitted as a result of the neutron emission and using the alpha particle detection to define the start of the predetermined time period. Additionally, the method may include the step of generating an analog signal having a pulse height proportional to a time interval and utilizing the analog signal to gate an analyzer to record a gamma ray energy spectrum for gamma ray emission occurring only during that time period. The analog signal may be generated based on the time interval between the start signal and a stop signal from gamma detection, or it may be generated experimentally. A discrete time band of the time information analog signal can then be analyzed to provide an energy spectrum for gamma ray emission occurring only at a known depth below the soil surface. Thus, a soil depth profile can be achieved.

The present invention further involves an apparatus for non-invasively determining the elemental characteristics of a portion of earth in-situ. The apparatus generally includes a neutron generator including an alpha detector, at least one gamma ray detector, a time analog converter/single channel analyzer (TAC/SCA) electrically connected to the neutron generator alpha detector and the gamma ray detector and a linear gate electrically connected to the TAC/SCA and the gamma ray detector.

The neutron generator is adapted to emit a burst of neutrons from a point on the earth's surface to a portion of subsurface earth sufficient to induce elemental gamma ray emission caused by inelastic neutron scattering within the subsurface earth portion. The alpha detector of the neutron generator detects the emission of an associated alpha particle upon generation of a neutron and generates a start signal upon detection of the associated alpha particle. The gamma ray detector generates gamma signals upon detection of gamma ray emission from the soil and further generates a stop signal. The TAC/SCA receives the start signal and the stop signal and generates an analog signal having a pulse height proportional to a time interval between the start and stop signals. The analog signal is used to drive the linear gate, whereby the linear gate permits passage therethrough of gamma signals based on the received analog signal.

In an alternative embodiment, the apparatus includes a neutron generator, a controller for controlling the emission of neutrons from the neutron generator, at least one gamma ray detector for detecting gamma ray emission, a time analog converter/single channel analyzer (TAC/SCA) electrically connected to the controller and the gamma ray detector and a linear gate electrically connected to the TAC/SCA and the gamma ray detector.

In the alternative embodiment, the controller generates a start signal upon emission of neutrons from the neutron generator. The gamma ray detector generates gamma signals upon detection of gamma ray emission and further generates a stop signal. The TAC/SCA receives the start signal from the controller and the stop signal from the detector and generates an analog signal having a pulse height proportional to a time interval between the start and stop signals. The analog signal is used to drive a linear gate, whereby the linear gate permits passage therethrough of gamma signals based on the received analog signal.

The present invention further involves an apparatus having improved gamma ray detector positioning and shielding. The apparatus generally includes a neutron generator, a gamma ray detector having a detection surface for detecting gamma ray emission and a detector fixture. The detector fixture includes a base having an opening formed therethrough and a support member fixed to the base adjacent the opening. The support member supports the detector whereby the detection surface is oriented adjacent the opening at an angle with respect to the base.

In a preferred embodiment, the detection surface of the detector is oriented at a 45° angle with respect to the base. Additionally, the apparatus further preferably includes a tubular shield supported against the support member of the fixture. The tubular shield has a bore for receiving the detector and is preferably made from a low melting point alloy containing bismuth, lead, tin and cadmium. The detector fixture is positioned on the earth surface adjacent the neutron generator so that an axis normal to the detection surface of the detector intersects with a vertical axis of the neutron generator.

The present invention is primarily directed to a rapid, non-invasive system for quantifying surface soil carbon content at depths up to 50 inches. The invention not only enables plant and soil scientists to understand the capacity of different soils to store carbon, but will also provide useful information about the role of plants in the carbon sequestration process and, in turn, their role in the global carbon cycle.

For a better understanding of the present invention, reference is made to the following detailed description to be taken in conjunction with the accompanying drawings and its scope will be defined in the appended claims.

### BRIEF DESCRIPTION OF THE DRAWINGS

FIG. 1 is a schematic illustration of the device formed in accordance with the present invention.

FIG. 2 is a block diagram showing the controller and computer system of the present invention.

FIG. 3 is a block diagram showing the preferred embodiment of the arrangement of components of the present invention.

FIG. 4 is a graphical representation of an analog signal generated by the TAC/SCA of FIG. 3.

FIG. 5 is a block diagram showing an alternative embodiment of the arrangement of components of the present invention.

FIG. 6 is a graphical representation of a typical INS gamma spectra obtained during the device calibration process.

FIG. 7 is a table showing the results of a preliminary device calibration process.

FIG. 8 is a graphical representation of a calibration curve formed as a result of the calibration process.

FIG. 9 is an example of a graphical representation of a typical INS gamma spectra obtained during the measurement process.

FIG. 10 is a perspective view of a preferred detector fixture of the present invention.

### DETAILED DESCRIPTION OF THE PREFERRED EMBODIMENTS

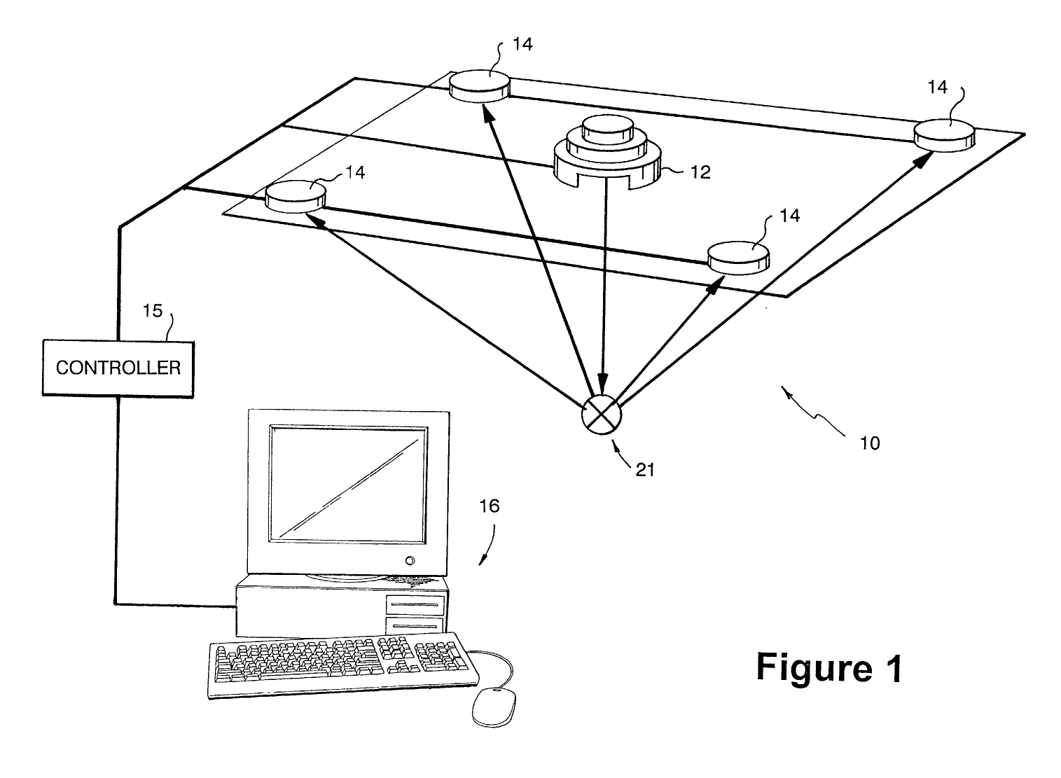

Referring to FIG. 1, the device 10 according to the present invention is a deployable field unit which generally comprises a neutron generator 12, a plurality of detectors 14, a controller 15 and a computer system 16, with associated data acquisition software, all of which are electrically connected. The controller 15 and computer system 16 may be integrated as one unit or may be separate units as shown in FIG. 1. The device is preferably in the form of a deployable kit that is easily set-up in the field and can be conveniently moved to other sites as desired.

The neutron generator 12 is preferably a Deuterium-Tritium (D-T) neutron generator, however other neutron generators with sufficient energy output may be used. The D-T neutron generator 12 preferably has an output of about 10⁸ n/sec, pulse width of 10 μsec and a repetition rate of 10⁴ pulses/sec. A suitable D-T neutron generator, for example, is Model No A-325 manufactured by MF Physics Corporation of Colorado Springs, Colo. A D-T neutron generator is based on the exoergic reaction between deuterium and tritium during which an alpha particle and 14 MeV neutrons are released. For the reaction to take place, deuterium ions are accelerated up to about 100 kV or higher and impinge upon a titanium target impregnated with tritium. Conventional generators which may be used are typically constructed in a sealed tube about 4 cm in diameter and 12 cm long with iron and/or lead shielding. A collimator is directed in the downward direction so that a neutron beam can penetrate the surface of the soil when the generator 12 is in position. Because the neutron generator is a pulsed system, it needs to be optimized with regard to time sequence and gating of the acquisition system.

The neutron beam penetrating the soil causes Inelastic Neutron Scattering (INS) within the soil which is detected by the detectors 14. INS is based on inelastic scattering of fast, 14 MeV, neutrons from carbon, ¹²C(n,n′γ)¹²C, and subsequent detection of the prompt emission of 4.44 MeV gamma rays from the first carbon excited level. Particularly, a neutron upon encountering a carbon scatters inelastically from its nucleus and at the same time raises it to an excited level. The excited nucleus decays promptly, less than one psec, to the ground level with concurrent emission of a 4.44 MeV gamma ray. This reaction requires fast neutrons for it to occur. Thus, conventional radioactive sources cannot be used. The fast 14 MeV neutrons are produced from the pulsed D-T neutron generator and the resulting gamma rays are counted for approximately one hour.

Preferably, the 4.44 MeV gamma rays emitted from carbon are detected using four gamma ray detectors 14. Depending on the size of the detectors and the physical characteristics of the testing site, more or fewer detectors may be used. For example, a particular testing site might call for a larger number of smaller detectors or a fewer number of larger detectors. Generally, the use of at least four detectors improves the detection limit and reduces the error factor. Suitable detectors include small Bismuth Germinate Oxide (BGO) scintillators, high purity Ge detectors or NaI(TI) detectors. The BGO scintillators, with higher density than NaI(TI) detectors, are preferred because they offer an improved efficiency as well as a better peak to Compton ratio.

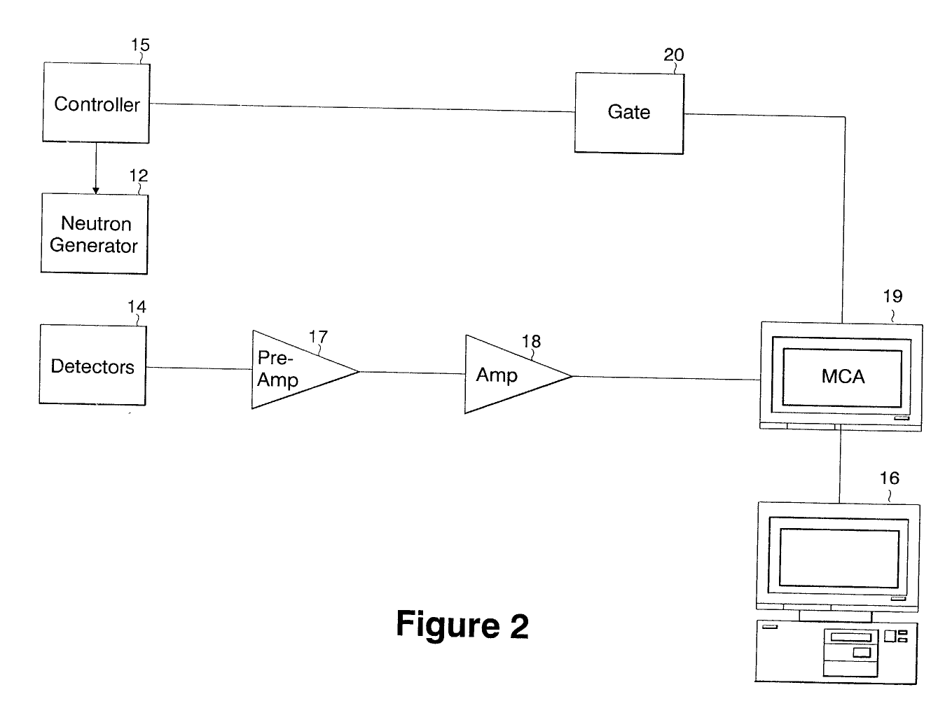

Referring additionally to FIG. 2, the controller 15 controls the operation of the neutron generator 12 and provides a gate signal for a multi-channel analyzer (MCA) 19. A pre-amplifier 17 and an amplifier 18 are used for signal conditioning for the detectors 14. The conditioned signals are sent to the MCA 19 that may be a stand alone unit or may be incorporated within the computer system 16. The MCA 19 includes an analog-digital converter that converts the energy signals from the detectors 14 to a pulse height that is analyzed and counted by the MCA. The MCA 19 is gated to the controller 15 so that signals are counted only during the time when the pulse is generated by the neutron generator. A coincidence gate 20 may be utilized to synchronize the counting of signals during the neutron pulse period. Thus, the MCA 19 and gate 20 can be programmed to initiate signal counting upon receiving a start signal from the controller 15 and to terminate or ignore signal counting after a predetermined time period, such as 10 microseconds.

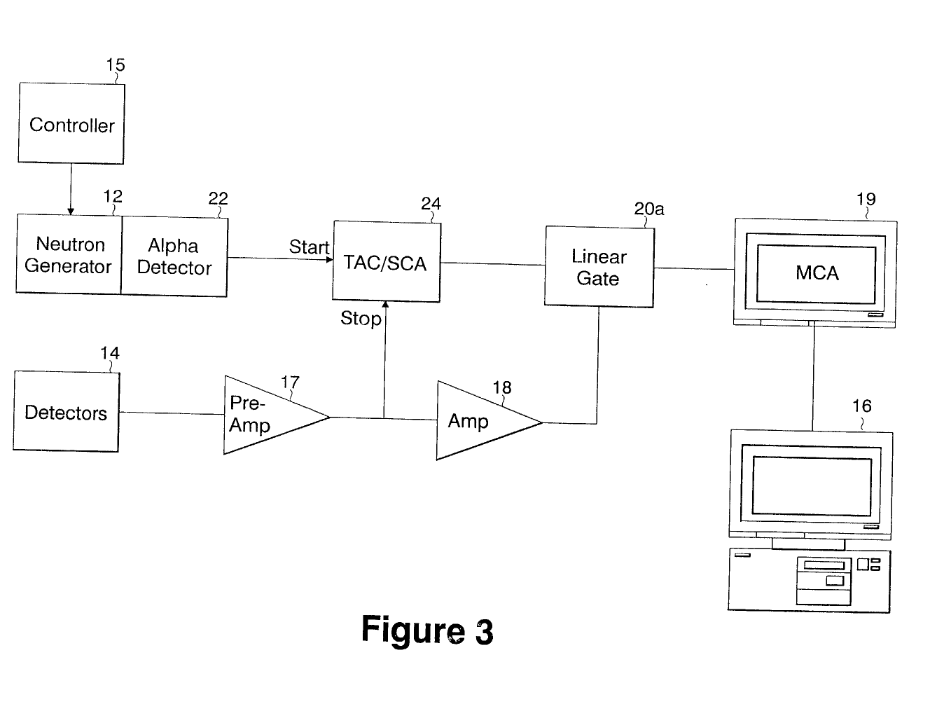

In a preferred embodiment, as shown in FIG. 3, an associated particle sealed tube neutron generator (APSTNG) 12a utilizing associated particle technology (APT) is used. The APSTNG 12a includes an alpha detector 22 that detects the associated emission of alpha particles as the deuterium ions impinge upon the titanium target of the D-T neutron generator. The alpha detector 22 is electronically connected to a time analog converter/single channel analyzer (TAC/SCA) 24 to transmit a start signal to the TAC/SCA upon detection of an alpha particle. The TAC/SCA 24 is also electronically connected to the detectors 14 for receiving a stop signal from the detectors upon detection of gamma rays from the soil. Thus, at the moment the neutron generator 12a begins to emit neutrons, the alpha detector 22 sends a start signal to the TAC/SCA 24 and, at the moment the detectors detect the associated gamma ray emission from the soil as a result of the neutron reaction with carbon in the soil, the detectors 14 send a stop signal to the TAC/SCA. The selected signal from the TAC/SCA 24 triggers a linear gate 20a to allow passage of the linear signal to the MCA 19. This eliminates the inclusion of any counts which are outside the time delay between the controller 15 and the neutron generator 12a into the counting window. Furthermore, any gamma ray signals detected before the start signal or after the stop signal are not allowed to pass through the linear gate 20a to the MCA 19. As a result, by electronically tagging the neutrons, background noise is reduced and system sensitivity is increased.

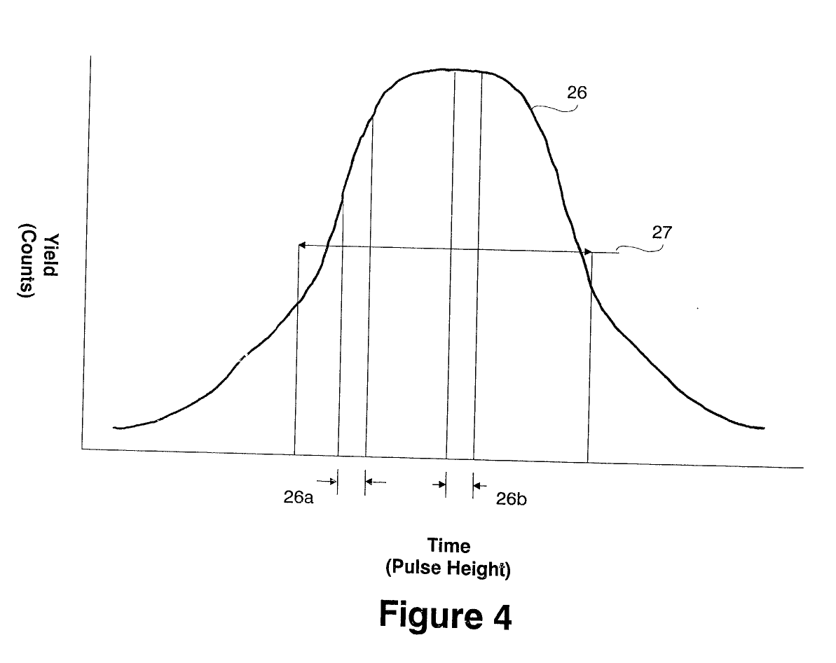

Based on the received start and stop signals, the TAC/SCA 24 converts the time interval into an analog signal 26 having a pulse height proportional to the time interval 27 as shown in FIG. 4. Thus, the time information can be integrated into the linear signal processing system for improved sensitivity. Additionally, by generating a time profile, it is possible to analyze only discrete time bands 26a or 26b of the analog signal distribution 26 to perform a soil depth profile analysis. For example, based on the speed of neutrons (5 cm/nsec), it can be determined that time band 26a relates to gamma ray emission detected at a depth of, for example, 5-10 cm below the soil surface, while time band 26b relates to gamma ray emission detected at a depth of, for example, 20-25 cm below the soil surface. Thus, to determine the carbon content present in the soil at 5-10 cm below the surface, only gamma ray signals received during time band 26a are considered. By integrating successive time bands, a full depth profile can be generated.

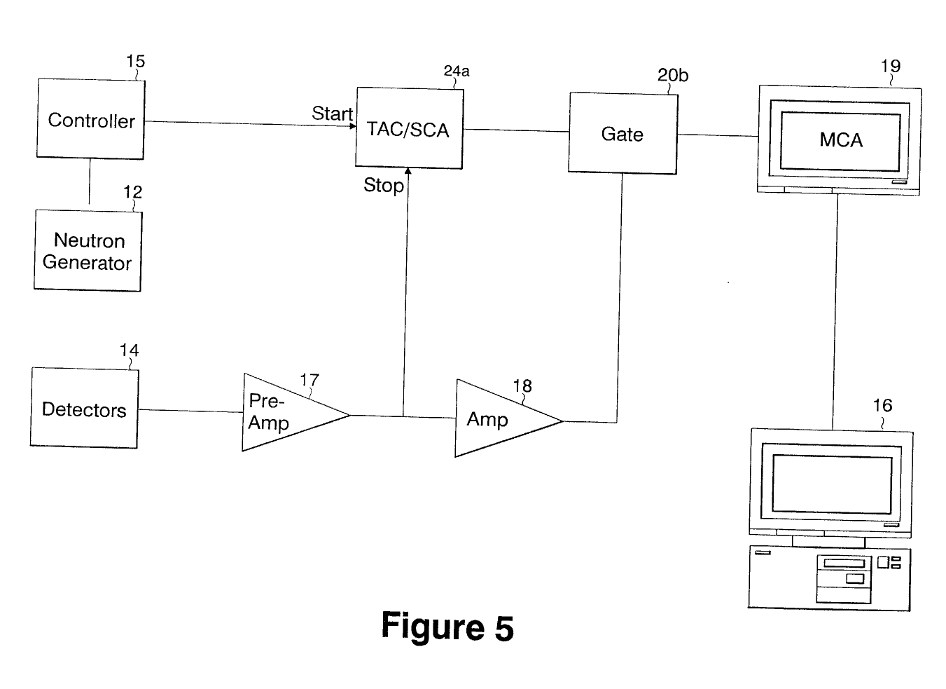

Alternatively, because APT neutron generators are typically expensive, the time information signal 26 can be derived experimentally, whereby a non-APT neutron generator 12 can be used in the system, as shown in FIG. 5. Here, the controller 15 sends a start signal to the TAC/SCA 24a upon initiation of neutron emission and the detectors 14 send a stop signal to the TAC/SCA upon detection of gamma rays. Based on an experimentally derived time profile, the gate 20b and the MCA 19 can be programmed to count signals only during start and stop signals that are, for example, 25 nanoseconds apart.

In all of the above embodiments, the computer system 16 includes data analysis software for generating energy spectra based on the counted signals analyzed by the MCA 19. The controller 15 and the computer system 16 can be incorporated in a single portable unit. Preferably, for increased portability, the PC computer also includes its own power supply.

Prior to use in the field, the device is calibrated in a laboratory using samples of soil having known weight percentages of carbon. Preferably, at least four trays or boxes of samples are prepared including a tray consisting of clean sand and mixtures of sands with carbon powder deposited therein at variable carbon concentrations, for example, 2%, 5% and 10% carbon by weight. It has been found during feasibility studies that 70-pound samples placed in trays or boxes and measured for one hour produces adequate calibration results. However, calibration is preferably performed using larger samples under controlled conditions that properly simulate the actual soil testing conditions of the site to be measured.

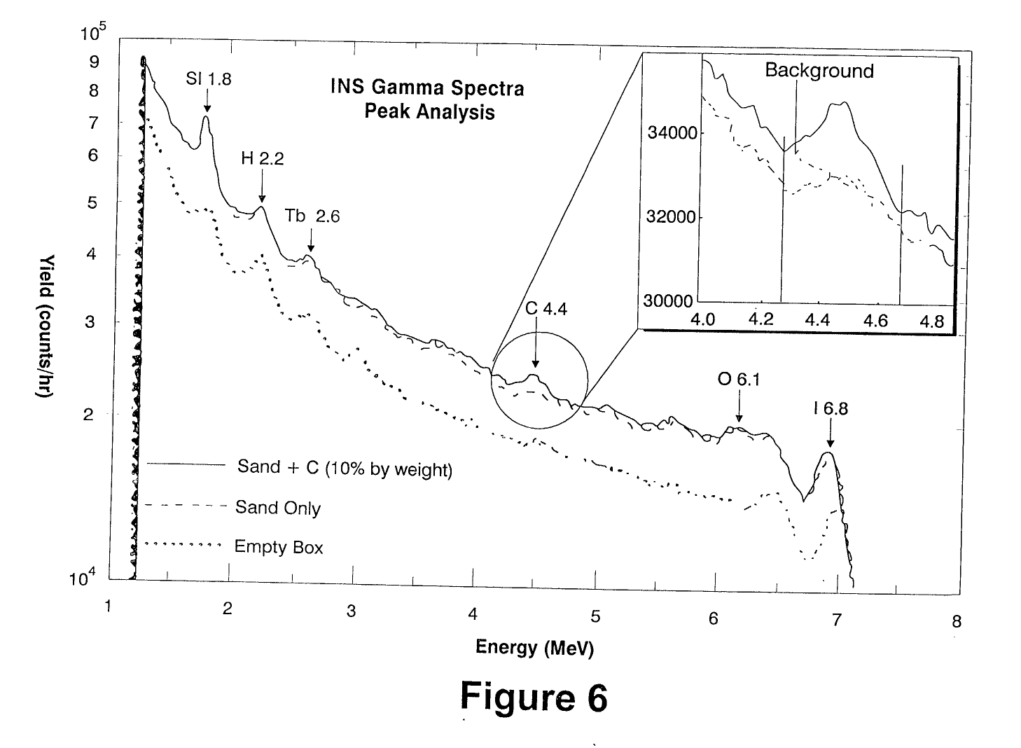

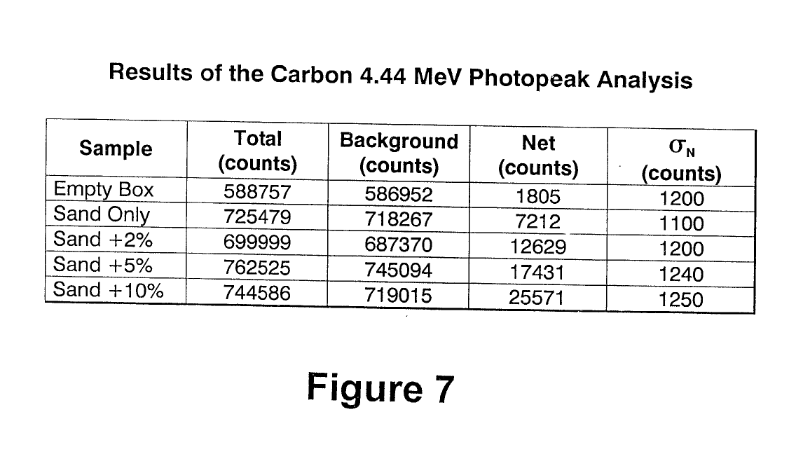

Feasibility studies were carried out with the neutron generator 12 placed in proximity to the samples and two detectors 14 used for calibration purposes to detect the resulting gamma rays. For each sample, the detectors measure the gamma rays emitted as a result of the INS effect. This information is sent to the computer system software 16 for INS gamma spectra peak analysis for each sample. For example, FIG. 6 shows the measured spectra of: 1) an empty aluminum box; 2) box with sand only; and 3) box with sand and 10% carbon powder by weight. The spectrum for the sample containing only sand is plotted with the spectra for each of the carbon containing soil samples in order to obtain a net gamma ray count for each sample. Typical results based on the measured spectra for each sample are summarized in FIG. 7. FIG. 7 shows 1) the total number of counts for each sample in the carbon photo peak (4.44 MeV); 2) the background number of counts; 3) the net number of counts which is derived from subtracting the background counts from the total counts; and 4) the errors in the net number of counts due to the counting statistics. Typically, the background number of counts is calculated using experimental data or through known graphical interpolation or Monte Carlo modeling techniques to isolate the carbon photopeak. In FIG. 7, the net number of counts represents the sum of the two detectors and a counting time of one hour.

The high net number of counts (7212) in the carbon photo peak in the sample without carbon (sand only in the table of FIG. 7) is due to single escape peak from the 4.9 MeV gamma line in silicon (Si) present in sand that results in a similar carbon 4.44 MeV gamma line. This contribution can also be seen in the spectrum of the sand alone in FIG. 6. However, since Si also has a strong line at 1.78 MeV (labeled in FIG. 6), using a properly calibrated ratio of the intensities of these two lines in Si, it is therefore possible to correct for Si contribution to the carbon photo peak.

Using the results of the carbon photo peak analysis at 4.44 MeV, a calibration plot is then formulated of the net number of counts in the carbon photo peak corrected for Si contribution. Specifically, the net count measured for sand only (7212 shown in FIG. 7) is subtracted from the counts for each of the samples containing carbon and the resulting carbon concentration is plotted as a straight line as shown in FIG. 8. The straight line in FIG. 8 is a linear regression fit to the data points obtained. These results were also confirmed using chemical analysis for carbon of the sand only sample and no carbon was found.

Based on these measurements, the detection limit, defined as three times the square root of the background, was determined to be about 1.4% carbon by weight for this INS system. The relative error in the net number of counts for the sample with 10% carbon is about 6.5%.

Using these calibration results, the device can now be taken into the field to determine soil carbon content at the surface of the soil. The device 10 is brought to a desired location and set-up on site. The neutron generator 12 is positioned on the surface of the soil with its collimator pointed in the downward direction. The detectors 14 are also placed on the soil surface in proximity to the neutron generator 12 in a spaced pattern. Preferably, the detectors 14 are positioned within 50-75 cm from the neutron generator 12 and are spaced symmetrically. The components are then electrically connected to the computer system 16.

During operation, the controller 15 sends a signal to the neutron generator 12 to cause the generator to emit a burst of 14 MeV neutrons. The burst of neutrons interacts with nuclei at a point 21 below the surface of the soil to induce emission of gamma radiation. This emitted gamma radiation is detected by the detectors 14 which, in turn, output signals back to the computer system 16 through the MCA 19. The amplitude output of the signals is proportional to the energy level of particular gamma rays of the gamma radiation detected, and the number of counts is proportional to the concentration of the element of interest. The computer system 16 includes data acquisition software including counting algorithms and data storage bins for processing the signals received from the detectors 14.

The INS gamma spectrum is further processed, as described above with respect to the calibration process, to determine the elemental properties of the soil. For example, to determine the weight percentage of carbon within the soil at the measured location, the total count at the carbon photo peak (4.44 MeV) is ascertained and a background count at the same energy window is determined by the trapezoidal method to isolate the carbon peak. Alternatively, the background count may be determined using known experimental data or through known Monte Carlo modeling techniques. The background count is then subtracted from the total count to obtain a net count at the carbon peak (4.44 MeV). The net count is then corrected for Si contribution by subtracting the net count obtained for the sand only sample during the calibration process. The corrected net count is then plotted on the calibration curve obtained during the calibration process (FIG. 8) to determine the weight percentage of carbon in the soil.

The number of counts in the detector can be expressed as a four dimensional integral with three spatial and particles energy variables. It is further complicated because of the transport of neutrons and photons. The yield in the number of counts in the carbon peak, Y_{C}, resulting from the transport integral in its very simplified form can be written as,

Y_{C=}k∫∫∫∫øₙ(x,y,z.E)σ(E)C_{C}(x,y,z)øₚ(x,y,z.E)D_{R}(E)dxdydzdE (1)

where: øₙ(x,y,z.E) is the neutron flux that is a function of the position and energy, øₙ in itself requires solution of an integral equation in order to be evaluated, σ (E) is the cross section for inelastic scattering from carbon, C_{C}(x,y,z) is spatial carbon distribution in soil, ø_{P}(x,y,z.E) is the photon flux, following the inelastic interaction in carbon, that reaches the detector, and D_{R}(E) is the response function of the detector. Solution of the Eq. 1 can be evaluated, for simplifying cases only, using numerical methods. An alternative way to access Y_{C} is to use probabilistic algorithms in order to estimate the value of Y_{C}. These algorithms, using random number generators, track the particles in the medium from its birth, in the source, until its death when it is detected in the detector, or leaks out of the system. For this purpose the system has to be well characterized and all the processes that take place must be formulated. These type of calculations are referred to as Monte Carlo calculations, one of the many codes developed for nuclear radiation transport is MCNP developed in Los Alamos National Laboratory (Briesmeister, J. F. Ed. 1997. The MCNP Transport Code, Version 4B. LA-12625-M).

In nuclear spectroscopy the objective in spectra analysis is twofold: (1) to evaluate the net number of counts in a photopeak of interest and (2) to relate the net number of counts to the elemental concentration. The first task can be accomplished in several ways and the one chosen here consists of evaluating the background, C_{B}, under the peak using the trapezoidal method, i.e., the background under the peak is assumed linear. Thus, the net number of counts, C_{N}, under the photopeak is given as,

C_{N}=C_{T}−C_{B} (2)

where C_{T} is the total number of counts and the error associated with the estimate of C_{N}, S_{N}, is given from the general error propagation as,

S²_{N}=S²_{N}+S²_{B} (3)

where S_{X} is the standard deviation of the variable x given as the square-root of number of counts x. It is apparent from Eqs. 2 and 3 that the peak intensity and the background are the controlling factors that determine the sensitivity and the signal-to-noise, S/N, ratio. To improve the performance it is possible either increase the peak, e.g., longer counting, or reduce the background by for example better shielding of the detectors or creating an accurate time gate. The noise is defined as the square-root of the background, thus the S/N and the minimum detection limit (MDL) are given as

S/N=C_{N}/sqrt(C_{B}) (4)

and

MDL=3 sqrt(C_{B}). (5)

This definition of MDL provides a confidence level that the signal is above background by three standard deviations.

The following is an illustrative example demonstrating the foregoing steps.

### EXAMPLE

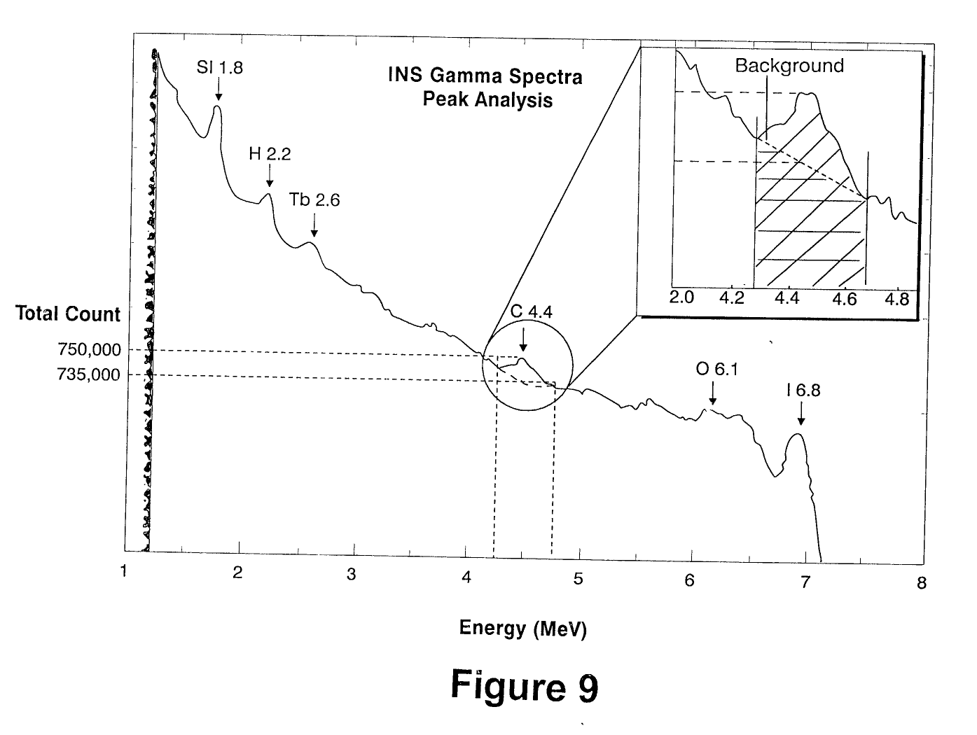

After calibrating and setting up the device on the surface of the soil as described above, an INS gamma spectra, as shown in FIG. 9, is obtained. From the spectra, a total count of 750,000 at the carbon photo peak (between about 4.3 and 4.7 MeV) is determined by integrating the total area under the peak. The carbon peak is isolated and a curve representing the background count is extrapolated using the trapezoidal method. By integrating the area under the extrapolated background curve, a background count of 735,000 is determined resulting in a net count of 15,000 (750,000−735,000). Using the calibration results obtained above, the net count is then corrected for Si contribution by subtracting 7212 (the net count for the sand only sample obtained during calibration shown in FIG. 4) to obtain a Si adjusted count of 7788. Visually plotting this count on the calibration curve of FIG. 8 reveals a weight percentage of carbon in the soil of approximately 4%. Of course, the data acquisition software can obtain the exact result for any obtained count based on accurate interpolation of the calibration curve.

Actual testing of the method and device using unknown soil samples taken from a local forest reveals that the INS system is quite accurate. The samples were studied double blind, once using the INS device of the present invention and tested again using conventional chemical analysis. In one such test, the INS system of the present invention detected a 2.1±0.2% carbon versus a chemical analysis of 1.7±0.1% carbon by weight.

The method thus described is also suitable for performing a compartmental analysis using stoichiometric relationships to identify the total carbon and the inorganic carbon components of the soil. Specifically, detection of calcium can also be achieved in the manner described above to assess the inorganic component of carbon and, thus, knowing the total, the organic carbon is obtained by calculating the difference. Thus, the organic carbon component can be written as:

Cₒ=(C−kCa−b)/aₒ (6)

where C is the total net number of counts in the carbon peak, kCa is the estimate of the inorganic carbon contribution based on the measured Ca peak and its calibration, b is any unaccounted background experimentally determined and aₒ represents an empirical and stoichiometric organic carbon factor.

Of course, any number of other elements having known energy peaks, such as silicon, hydrogen, oxygen, iodine and nitrogen, can be measured using this method. To determine the weight percentage of other elements in the soil, net gamma ray counts are calculated as described above at other known energy levels corresponding to the other elements. As a result, an element by element analysis of the measured soil can be determined.

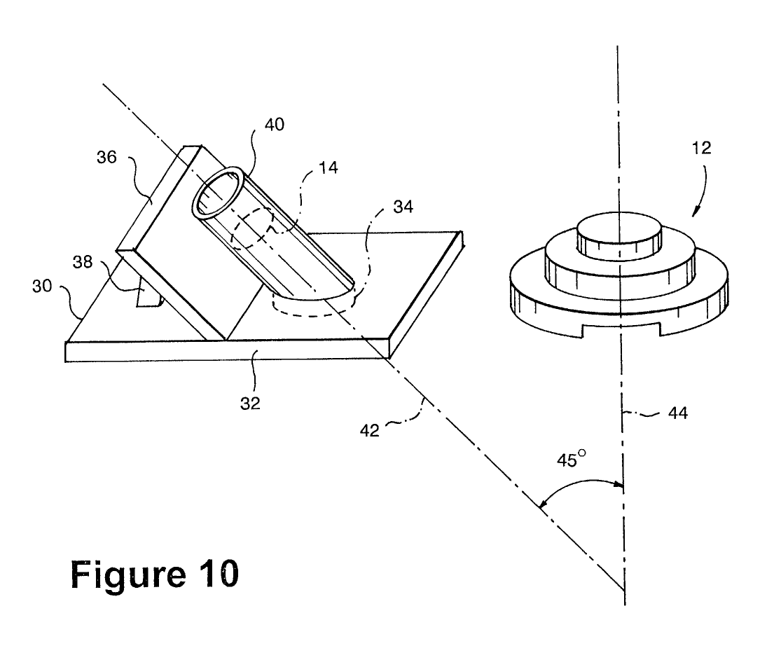

System sensitivity can be further improved by accurately positioning and sufficiently shielding the detectors 14. FIG. 10 shows a detector fixture 30, which is preferably used in the present invention for accurately positioning and sufficiently shielding the detectors 14. The detector fixture 30 includes a base 32 having an opening 34 therethrough and a support member 36 fixed at an angle to the base. The base 32 and the support member 36 are preferably made from aluminum and are welded together along with a bracket 38 for added strength. The support member 36 is preferably at a 45° angle with respect to the base 32 and is positioned adjacent the opening 34. Supported against the support member 36 is a tubular shield 40 having an inner diameter sized to receive a detector 14 therein. The tubular shield 40 may be made from lead or borax, however, it has been found that a low melting point alloy containing bismuth, lead, tin and cadmium provides superior shielding due to cadmium's ability to absorb neutrons. A preferred material for the tubular shield is known in the field as cerrobend.

The detector fixture 30 is positioned adjacent the neutron generator 12 so that, with the detector 14 seated in the cerrobend tubular shield 40 of the fixture, the central axis 42 of the detector is at a 45° angle with respect to the vertical collimator axis 44 of the neutron generator 12. As such, the detector 14 is aimed to point at a location below the soil surface directly under the neutron generator. By pointing the detector 14 at a location under the neutron generator 12, detection accuracy is improved and background noise is reduced. The superior shielding ability of the cerrobend tubular shield 40 further ensures that minimal stray gamma rays will be detected.

Thus, while there have been described what are presently believed to be the preferred embodiments of the invention, those skilled in the art will realize that changes and modifications may be made thereto without departing from the spirit of the invention, and is intended to claim all such changes and modifications as fall within the true scope of the invention.

1. A method for non-invasively determining the elemental characteristics of a portion of earth in-situ comprising the steps of:
emitting a burst of neutrons from a point on the earth's surface to a portion of subsurface earth sufficient to induce elemental gamma ray emission caused by inelastic neutron scattering within said subsurface earth portion;
detecting said gamma ray emission at discrete energy levels at more than one location proximal said point of emission to provide an energy spectrum;
analyzing said spectrum based on known elemental gamma ray energy levels to determine a total number of gamma ray counts within an energy band of said energy spectrum, said energy band representing a known elemental photo peak;
analyzing said spectrum to determine a background count of gamma rays within said energy band of said energy spectrum;
subtracting said background count of gamma rays from said total number of gamma ray counts to determine a net number of gamma ray counts within said energy band; and
using said net number of gamma ray counts to determine the weight percentage of an element corresponding to said known elemental photo peak within of said earth portion.

2. The method as defined in claim 1, wherein the neutrons are emitted from a pulsed neutron generator positioned on an upper soil surface.

3. The method as defined in claim 2, wherein the pulsed neutron generator is a Deuterium-Tritium (D-T) neutron generator.

4. The method as defined in claim 1, wherein the gamma ray emission is detected by four detectors.

5. The method as defined in claim 1, wherein the emitted neutrons have an energy level of 14 MeV.

6. The method as defined in claim 1, wherein the step of analyzing said energy spectrum is performed using nuclear spectroscopy.

7. The method as defined in claim 1, wherein the background count is determined through graphical interpolation of said energy spectrum.

8. The method as defined in claim 1, wherein said net count is compared to a predetermined calibration plot to determine the weight percentage of said element corresponding to said known elemental photo peak within said portion of subsurface earth.

9. The method as defined in claim 8, wherein said calibration plot is determined by analyzing a number of soil samples, each having a known weight percentage of a predetermined element, and plotting a net number of gamma ray counts for each soil sample.

10. The method as defined in claim 8, wherein said desired element is carbon and said predetermined energy level is 4.44 MeV.

11. The method as defined in claim 10, wherein the net count is adjusted for silicon.

12. The method as defined in claim 11, wherein the net count is adjusted by subtracting a net count determined by analyzing a soil sample having no carbon present, whereby the net count is corrected for silicon contribution.

13. The method as defined in claim 10, further comprising the steps of:
determining a net number of gamma ray counts for calcium; and
comparing said net calcium count with said net carbon count to determine the inorganic component of carbon within said subsurface earth portion.

14. The method as defined in claim 1, wherein the step of analyzing said spectrum is performed using a portable computer system having data acquisition software.

15. The method as defined in claim 1, wherein said energy spectrum is provided for gamma ray emission occurring only during a predetermined time period.

16. The method as defined in claim 15, further comprising the step of detecting an associated alpha particle emitted as a result of said neutron emission, said alpha particle detection defining the start of said predetermined time period.

17. The method as defined in claim 1, further comprising the step of generating an analog signal having a pulse height proportional to a time period, said analog signal being used to provide an energy spectrum for gamma ray emission occurring only during said time period.

18. The method as defined in claim 17, further comprising the step of analyzing a discrete time band of said analog signal to provide an energy spectrum for gamma ray emission occurring only at a known depth below the soil surface.

19. An apparatus for non-invasively determining the elemental characteristics of a portion of earth in-situ comprising:
a neutron generator for emitting a burst of neutrons from a point on the earth's surface to a portion of subsurface earth sufficient to induce elemental gamma ray emission caused by inelastic neutron scattering within said subsurface earth portion, said neutron generator including an alpha detector for detecting the emission of an associated alpha particle upon generation of a neutron, said alpha detector generating a start signal upon detection of said associated alpha particle;
at least one gamma ray detector for detecting said gamma ray emission, said gamma ray detector generating gamma signals upon detection of said gamma ray emission and further generating a stop signal;
a time analog converter/single channel analyzer (TAC/SCA) electrically connected to said alpha detector and said gamma ray detector for receiving said start signal and said stop signal, said TAC/SCA generating an analog signal having a pulse height proportional to a time interval between said start and stop signals; and
a linear gate electrically connected to said TAC/SCA and said gamma ray detector for receiving said analog signal and said gamma signals, said linear gate permitting passage therethrough of said gamma signals based on said received analog signal.

20. An apparatus for non-invasively determining the elemental characteristics of a portion of earth in-situ comprising:
a neutron generator for emitting a burst of neutrons from a point on the earth's surface to a portion of subsurface earth sufficient to induce elemental gamma ray emission caused by inelastic neutron scattering within said subsurface earth portion;
a controller for controlling the emission of neutrons from said neutron generator, said controller generating a start signal upon emission of neutrons from said neutron generator;
at least one gamma ray detector for detecting said gamma ray emission, said gamma ray detector generating gamma signals upon detection of said gamma ray emission and further generating a stop signal;
a time analog converter/single channel analyzer (TAC/SCA) electrically connected to said controller and said gamma ray detector for receiving said start signal from said controller and said stop signal from said detector, said TAC/SCA generating an analog signal having a pulse height proportional to a time interval between said start and stop signals; and
a linear gate electrically connected to said TAC/SCA and said gamma ray detector for receiving said analog signal and said gamma signals, said linear gate permitting passage therethrough of said gamma signals based on said received analog signal.

21. An apparatus for non-invasively determining the elemental characteristics of a portion of earth in-situ comprising:
a neutron generator for emitting a burst of neutrons from a point on the earth's surface to a portion of subsurface earth sufficient to induce elemental gamma ray emission caused by inelastic neutron scattering within said subsurface earth portion;
a gamma ray detector having a detection surface for detecting said gamma ray emission; and
a detector fixture including a base having an opening formed therethrough and a support member fixed to said base adjacent said opening, said support member supporting said detector whereby said detection surface is oriented adjacent said opening at an angle with respect to said base.

22. The apparatus as defined in claim 21, wherein said detection surface of said detector is oriented at a 45° angle with respect to said base.

23. The apparatus as defined in claim 21, further comprising a tubular shield supported against said support member, said tubular shield including a bore for receiving said detector.

24. The apparatus of claim 23, wherein said tubular shield is made from a low melting point alloy comprising bismuth, lead, tin and cadmium.

25. The apparatus of claim 21, wherein said detector fixture is positioned on the earth surface adjacent said neutron generator so that an axis normal to said detection surface of said detector intersects with a vertical axis of said neutron generator.
